(19) United States
(12) Patent Application Publication
(10) Pub. No.: US 2025/0308112 A1
(43) Pub. Date: Oct. 2, 2025

(54) PRIVACY ENHANCED IMAGES FOR LIGHTING DESIGN

(71) Applicant: SIGNIFY HOLDING B.V., EINDHOVEN (NL)

(72) Inventors: ROHIT KUMAR, ACTON, MA (US); DAKSHA YADAV, BOSTON, MA (US); PETER DEIXLER, ARLINGTON, MA (US); SHAHIN MAHDIZADEHAGHDAM, MILPITAS, CA (US)

(21) Appl. No.: 18/864,096

(22) PCT Filed: May 2, 2023
(86) PCT No.: PCT/EP2023/061505

§ 371 Date: Nov. 8, 2024

Related U.S. Application Data
(60) Provisional application No. 63/340,557, filed on May 11, 2022.

(30) Foreign Application Priority Data
Jun. 9, 2022 (EP) 22178146.1

(51) Int. Cl. G06T 11/60; G06V 10/764

(52) U.S. Cl. CPC G06T 11/60; G06V 10/764

(57) ABSTRACT

A computer-implemented method of generating a synthetic image of a space for lighting design includes obtaining an input image of the space and performing parsing of the input image of the space to detect objects in the input image. The method further includes classifying the objects detected in the input image at least based on relevance to lighting design of the space and relevance to privacy. The method also includes generating a synthetic image of the space from the input image of the space. A first object of the objects in the input image is included in the synthetic image, and a second object of the objects in the input image is left out from the synthetic image. The first object is relevant to the lighting design, and the second object is relevant to privacy.

### TECHNICAL FIELD

The present disclosure relates generally to lighting solutions, and more particularly to privacy-enhanced images for use in lighting design.

### BACKGROUND

Some lighting systems can be designed to provide personalized lighting. Some lighting systems can also be configured to provide different lighting scenes. For example, a lighting design may be performed based on a type of room, regular activities in a room, special events that may be held in the room, etc. In some cases, it may be desirable to obtain personalized lighting advice, for example, from a lighting professional. A consumer may also want a lighting professional to perform a lighting design of a space, such as a room or an entire residence. A lighting professional may be able to remotely perform the lighting design of a space based on one or more images of the space provided by a consumer. However, due to privacy concerns, consumers may be hesitant to provide images of a space, such as a living room, bedroom, a kitchen, etc., to a lighting professional. Thus, a solution that reduces the privacy concerns of consumers related to sharing images of a space with a remote lighting design professional or with other people may be desirable.

### SUMMARY

The present disclosure relates generally to lighting solutions, and more particularly to privacy-enhanced images for use in lighting design. In an example embodiment, a computer-implemented method of generating a synthetic image of a space for lighting design includes obtaining an input image of the space and performing parsing of the input image of the space to detect objects in the input image. The method further includes classifying the objects detected in the input image at least based on relevance to lighting design of the space and relevance to privacy. The method also includes generating a synthetic image of the space from the input image of the space. A first object of the objects in the input image is included in the synthetic image, and a second object of the objects in the input image is left out from the synthetic image. The first object is relevant to the lighting design, and the second object is relevant to privacy.

In another example embodiment, a device for generating a synthetic image of a space for lighting design, the device comprising a processor configured to obtain an input image of the space and perform parsing of the input image of the space to detect objects in the input image. The processor is further configured to classify the objects in the input image of the space at least based on relevance to lighting design of the space and relevance to privacy. The processor is also configured to generate a synthetic image of the space from the input image of the space. A first object of the objects in the input image is included in the synthetic image, and a second object of the objects in the input image is left out of the synthetic image. The first object is relevant to the lighting design, and the second object is relevant to privacy.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a functional system for generating a synthetic image of a space according to an example embodiment;

FIG. 2 illustrates a room intended for lighting design using a synthetic image according to an example embodiment;

FIG. 3 illustrates a functional system for generating a synthetic image of a space according to another example embodiment

FIG. 4 illustrates a functional system for generating a synthetic image of a space according to another example embodiment

FIG. 5 illustrates a device for generating a synthetic image of a space for lighting design according to an example embodiment; and

FIG. 6 illustrates a method of generating a synthetic image of a space for lighting design according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings may designate like or corresponding but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

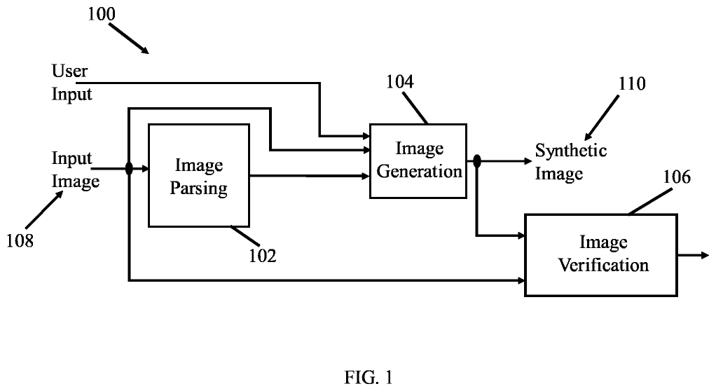

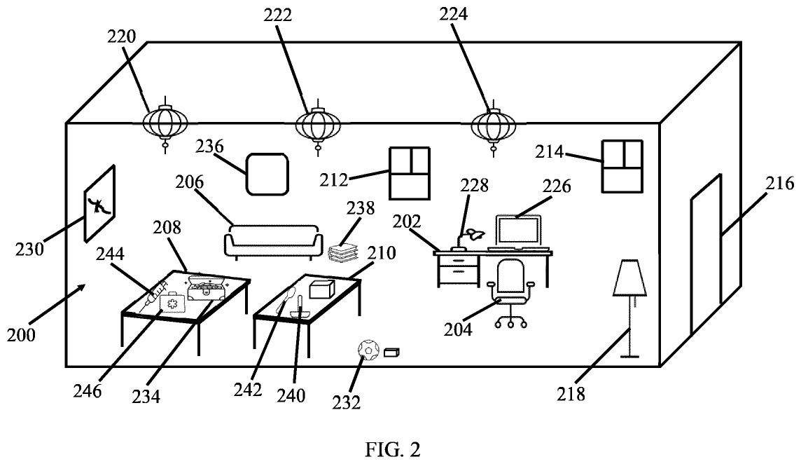

FIG. 1 illustrates a functional system 100 for generating a synthetic image 110 of a space according to an example embodiment, and FIG. 2 illustrates a room 200 intended for lighting design using the synthetic image 110 according to an example embodiment. The synthetic image 110 may be an image that is generated by the system 100 based on an input image 108, where some objects in the input image 108 may be included in the synthetic image 110, where some objects in the input image 108 may be left out of the synthetic image 110, and where the synthetic image 110 includes some objects that are not in the input image 108. The synthetic image 110 is intended to provide a level of privacy protection to the owner/occupant of the room 200 shown in the input image 110. The synthetic image 110 may be a fully artificially generated image that looks as realistic as real images, or the synthetic image 110 may be an image which augments aspects taken from a real image of the user's space (e.g., the room 200) and augments them with other aspects that are artificially generated. As shown in FIG. 1, in some example embodiments, the system 100 includes an image parsing module 102 and an image generator module 104. The system 100 may also include an image verification module 106. The image parsing module 102 may receive or otherwise obtain the input image 108 and parse the image to detect objects in the input image 108. For example, the input image 108 may be an image of the room 200.

In some example embodiments, the room 200 may contain a desk 202, a chair 204 proximal to the desk 202, a sofa 206, tables 208, 210, a TV, a gaming computer, etc.

The room 200 may have windows 212, 214 and a door 216. The windows 212, 214 and the door 216 may allow light to enter into the room 200. The room 200 may also contain a freestanding lamp 218, light fixtures 220, 222, 224 (e.g., suspended light fixtures), and a desk lamp 228 that is on the desk 202. A mirror 236 may be attached to a wall of the room 200.

In some example embodiments, a laptop 226 and/or other electronic devices may be on the desk 202. A framed artwork 230 may be on a wall of the room 200, and a ball 232, a stack of books 238, and other miscellaneous objects may be on the floor of the room 200. A jewelry box 234 and health related objects, such as a syringe 244 and a medical kit box 246, may be on the table 208. Objects, such as a candle 240 and a spoon 242, may be on the table 210.

In some example embodiments, the image parsing module 102 may parse the input image 108 to determine the type of the room 200 and/or the design style of the room 200. For example, the image parsing module 102 may include one or more neural networks that are trained to classify a room included in an image. To illustrate, the image parsing module 102 may include a convolutional neural network (CNN) that is trained to classify a room included in the input image 108 as a bedroom, a living room, a home office, a dining room, a bathroom, a kitchen, a walk-in closet, a game room, a patio, a relaxation room, a den, a mixed-use room, or another type of room as can be readily contemplated by those of ordinary skill in the art. For example, information related to room type/scene classification methods is described in Zhou, Bolei & Lapedriza, Agata & Xiao, Jianxiong & Torralba, Antonio & Oliva, Aude. (2015), “Learning Deep Features for Scene Recognition using Places Database”. The image parsing module 102 may classify a room based on the particular furniture pieces present in the room as captured in the input image 108. In some example embodiments, the image parsing module 102 may also perform a more refined classification of a room included in the input image 108 by classifying, for example, a room as a boy's bedroom, a girl's bedroom, a romantic bedroom, etc.

In some example embodiments, the image parsing module 102 may determine that the room 200 as shown in the input image 108 is a home office or a home office-relaxation mixed use room. The image parsing module 102 may provide a classification output indicating the type of the room 200 to other components of the image parsing module 102 and/or to other components of the functional system 100 and may save the room type information in a memory device, for example, for subsequent transmission and/or for display. In some example embodiments, the image parsing module 102 may determine the design style of the room 200 from the input image 108. For example, the image parsing module 102 may include one or more neural networks that are trained to classify a design style of a room included in an image. To illustrate, the image parsing module 102 may include a CNN (or Transformer or other type of neural network(s)) that is trained to classify the design style of a room included in the input image 108 as modern, casual, classic, natural, or another design style as can be readily contemplated by those of ordinary skill in the art. For example, the image parsing module 102 may classify and determine the design style of a room based on the particular types of furniture pieces, artwork, and other objects present in the room as captured in the input image 108. In some example embodiments, the image parsing module 102 may also perform a more refined classification of the design style of a room included in the input image 108. For example, the image parsing module 102 may classify the design style of a room as Colonial, Victorian, Bohemian, Contemporary, Coastal, Rustic, etc.

In some example embodiments, the image parsing module 102 may determine that the design style of the room 200 as shown in the input image 108 is, for example, casual. The image parsing module 102 may provide a classification output indicating the design style of the room 200 to other components of the image parsing module 102 and/or to other components of the functional system 100 and may save the design style information in a memory device, for example, for subsequent transmission and/or display.

In some example embodiments, the image parsing module 102 may parse the input image 108 to detect and classify objects in the input image 108. For example, the image parsing module 102 may include one or more CNN components that are trained to detect and classify objects in the input image 108 as can be readily understood by those of ordinary skill in the art. For example, one or more CNN components of the image parsing module 102 may be based on You Only Look Once (YOLO), single-shot multibox detector 20 (SSD), region-based CNN (R-CNN), Fast R-CNN, Faster R-CNN, region-based fully convolutional networks, (R-FCN), Mask R-CNN, or another neural network architecture suited for object detection as can be readily understood by those of ordinary skill.

In some example embodiments, the image parsing module 102 may detect the objects in the room 200 that are included in the input image 108. For example, the image parsing module 102 may detect the desk 202, the chair 204, the sofa 206, the tables 208, 210. The image parsing module 102 may also detect the windows 212, 214 and the door 216. The image parsing module 102 may also detect the freestanding lamp 218, the light fixtures 220, 222, 224, the desk lamp 228, and the mirror 236. The image parsing module 102 may also detect the laptop 226, the framed artwork 230, the ball 232, the stack of books 238, and the other miscellaneous objects on the floor of the room 200. The image parsing module 102 may also detect the jewelry box 234, the candle 240, the spoon 242, the syringe 244, and the medical kit box 246. The image parsing module 102 may also detect walls, the floor, and ceiling of the room 200 from the input image 108.

In some example embodiments, the parsing module 102 may also determine the relative positions and/or locations of detected objects in the input image 108. For example, one or more CNN components of the image parsing module 102 may include Faster R-CNN and/or Mask R-CNN components that can determine locations of objects (e.g., locations of bounding boxes of objects or pixel locations corresponding to objects). The image parsing module 102 may determine relative locations of detected objects based on the locations of the objects. The location information for detected objects can include, but is not limited to, a position of the object within the room 200, a distance from one or more other objects within the room 200, coordinates of the object within the room 200 and/or within the input image 108, and/or an area of the room 200 where the object is located at within the room 200. The location information for detected objects can also include, but is not limited to, orientation between a first object (e.g., a TV in the center of the room 200) with respect to a second object (e.g., a couch) or a third object (e.g., a dining table) within the input image 108 and/or an area of the room 200 where the object is located at within the room 200.

In some example embodiments, Light Detection and Ranging (Lidar) information, which may be represented in Cartesian coordinates (i.e., x, y, z coordinates) with respect to a reference location, may be embedded in the input image 108 or separately provided to the image parsing module 102 along with the input image 108. For example, the Lidar information may be obtained by a camera device simultaneously with the input image 108. The image parsing module 102 may use the Lidar information in conjunction with pixel locations in the input image 108 to determine locations of objects in the room 200, as captured in the input image 108, as can be readily understood by those of ordinary skill in the art with the benefit of this disclosure.

In some example embodiments, the image parsing module 102 may classify detected objects based on relevance to a desired design aspect (e.g., lighting design, office design, furniture design, decorating a room) and relevance to privacy. For example, the image parsing module 102 may classify detected objects based on relevance to lighting design and relevance to privacy. Relevance to lighting includes lighting design objects and objects that impact a lighting design of a space. For example, lighting design objects can include objects that provide light, reflect light, shade light, block light or in some way impact the light distribution within the space over one or more areas (e.g., corners, walls, ceilings, floors) of the space. In general, one or more CNN components of the image parsing module 102 may be pre-trained to classify objects as based on various requirements/constraints as can be readily understood by those of ordinary skill in the art with the benefit of this disclosure. For example, one or more CNN components of the image parsing module 102 may be pre-trained to classify light fixtures, windows, light transmissive objects, and light reflective objects as being relevant to lighting design and as corresponding to lighting design objects. In some example embodiments, one or more CNN components of the image parsing module 102 may be pre-trained to classify wall décor, furniture, structures, structure positioning (e.g., wall positioning, ceiling height), fixtures, and selected objects as being relevant to a desired design aspect or room layout or as a lighting design object. To illustrate, the image parsing module 102 may classify the freestanding lamp 218, the light fixtures 220, 222, 224, the desk lamp 228, the windows 212, 214, the door 216, and the mirror 236 as relevant to the lighting design of the room 200 and being or corresponding to a lighting design object of the space. Although the image parsing module 102 is described herein for example embodiments as classifying objects as relevant to a lighting design, it should be appreciated that the image parsing module 102 can classify objects of an input image 108 of any type and relevant to any selected or desired filter and/or design. For example, the image parsing module 102 can configured to classify objects of an input image 108 based in part on a provided filter or design aspect provided by a user, administrator and/or parameters of the image parsing module 102. The filters and/or design aspects can include, but are not limited to, privacy concerns, room architecture, room design, interior decoration, room construction and/or environment design.

In some example embodiments, the one or more CNN components of the image parsing module 102 may also be pre-trained to classify some objects as relevant to lighting design by default. For example, the image parsing module 102 may classify relatively large pieces of furniture (e.g., desks, chairs, sofas, tables, a TV, a gaming computer) as relevant to lighting design and as being or corresponding to a lighting design object. To illustrate, the image parsing module 102 may by default classify the desk 202, the chair 204, the sofa 206, and the tables 208, 210 as relevant to lighting design of the room 200 and as a lighting design object. Relevant to the lighting design and lighting design objects can include or refer to, but is not limited to, how objects impact the lighting within the respective room 200. For example, in some embodiments, relevant to the lighting design can include the impact the lighting provided from lighting fixtures (e.g., 220, 222, 224) within the room 200, the impact of light reflecting from or due to the respective objects or surfaces of the respective objects, the impact of positioning of one or more windows (e.g., 212, 214) that can allow light into the room 200 (e.g., ambient light, light from outside, light from another room), the impact of the positioning of one or more doors (e.g., the door 216) that can allow light into the room 200, and/or the impact of objects such as a mirror (e.g., the mirror 236) that can reflect or provide light to one or more areas of the room 200.

In some example embodiments, the image parsing module 102 may determine the relevance of pieces of furniture and other objects to lighting design and a lighting design object based on the type of the room 200 as determined by the image parsing module 102 as described above. For example, if the image parsing module 102 determines that the room 200 is a home office, the image parsing module 102 may classify the desk 202 and the chair 204 as relevant to lighting design (e.g., lighting design object) and may classify the sofa 206 as not relevant to light design (e.g., not a lighting design object). As another example, if the image parsing module 102 determines that the room 200 is a home office-relaxation mixed use room, the image parsing module 102 may classify the desk 202 and the chair 204 as well as the sofa 206 as relevant to lighting design and classify the stack of books 238 as relevant to lighting design because of the proximity of the stack of books 238 to the sofa 206.

In some example embodiments, the image parsing module 102 may determine whether an object is relevant to lighting design based on a user input provided to the image parsing module 102 indicating the desired lighting for the room 200. For example, if the user input indicates that computer-related work lighting, the image parsing module 102 may determine that the sofa 206 is not relevant to lighting design and may determine that the desk 202, the chair 204, and the laptop 226 are relevant to lighting design of the room 200.

As described above, the image parsing module 102 may classify objects based on relevance to privacy (e.g., privacy settings). Relevance to privacy as used herein can include or refer to privacy settings and/or objects that meet or do not meet one or more privacy settings. To illustrate, the image parsing module 102 may include one or more CNN components that are pre-trained to classify objects as being relevant to privacy (i.e., privacy sensitive, privacy settings). The privacy settings can include, but are not limited to, default privacy settings, user provided privacy settings, administrator privacy settings and/or privacy settings corresponding to a particular setting of the room (e.g., work, office related settings, building related settings). To illustrate, the image parsing module 102 may, by default, classify health related objects as relevant to privacy. For example, the image parsing module 102 may classify the syringe 244 and the medical kit box 246 as privacy sensitive objects (e.g., meeting one or more privacy settings). The image parsing module 102 may also classify jewelry and related objects as relevant to privacy by default. For example, the image parsing module 102 may classify the jewelry box 234 as a privacy sensitive object. The image parsing module 102 may also classify a first photo frame showing a person as privacy sensitive object, while it may classify a second photo frame showing a sunset landscape as non-privacy sensitive object although the sunset landscape is relevant to the lighting design.

In some example embodiments, the image parsing module 102 may classify one or more objects as relevant to privacy and/or meeting one or more privacy settings based on the locations of the objects. To illustrate, the one or more CNN components of the image parsing module 102 may be pre-trained to classify objects as privacy sensitive based on the relative locations of combinations of objects. For example, the image parsing module 102 may classify the candle 240 and/or the spoon 242 as privacy sensitive based on the proximity of the objects to each other although each individual object may not be considered a privacy sensitive object on its own. In some embodiments, the privacy settings may indicate or include a distance metric to identify an object as being privacy sensitive or not privacy sensitive. The distance metric can vary based at least on the type of space and/or the objects involved.

In some example embodiments, the image parsing module 102 may determine that one or more objects in the room 200 are relevant to both lighting design and privacy. For example, the image parsing module 102 may determine that some artworks are relevant to both lighting design and privacy. To illustrate, the artwork 230 may be considered as relevant to lighting design because lighting can affect the aesthetic appearance of the artwork 230, and the artwork 230 may be considered as privacy sensitive because of possible associated high financial value. As another example, the mirror 236 may be relevant to both lighting design and privacy. For example, the mirror 236 may be considered privacy sensitive because, for example, objects outside of the room 200 or the camera's field of view may appear in the mirror 236 and may be captured in the input image 108. In such cases, the image parsing module 102 may classify an object as relevant to lighting design or relevant to privacy (i.e., privacy sensitive) based on, for example, a user input indicating the privacy sensitivity of the user. Alternatively or in addition, the image parsing module 102 may request for a user input indicating whether a particular object is privacy sensitive. For example, a user may be requested (e.g., via a display interface) to provide a user input indicating whether the mirror 236 should be classified as privacy sensitive, and the image parsing module 102 may classify the object as relevant to lighting design or privacy based on the user input.

In some example embodiments, the image parsing module 102 may include one or more CNN components that are pre-trained to extract features from the input image 108 and determine a primary activity area in the room 200. The image parsing module 102 may determine whether an object is relevant to lighting design based on the relative locations of the primary activity area and the object. For example, the image parsing module 102 may classify the mirror 236 as being not relevant to the lighting design of the room 200 based on the relative distance of the mirror 236 from the desk 202, which the image parsing module 102 may determine as being a primary activity area in the room 200. Alternatively, the mirror 236 may be classified as being relevant to light design with privacy concern such that reflections in the mirror 236 are left out of when the synthetic image 110 is generated by the image generation module 104.

In some example embodiments, the image parsing module 102 may classify miscellaneous objects, such as the ball 232, as not relevant to lighting design. For example, one or more CNN components of the image parsing module 102 may be pre-trained such that the image parsing module 102 classifies some objects, such as the ball 232, as being not relevant to lighting design based on the classification of the room 200 as a home office.

In some example embodiments, the image parsing module 102 may perform, by default or based on user input, multiple sets (e.g., two sets, more than two sets) of classifications that are based on different privacy level requirements. Each of the different sets of classifications can include or correspond to a different privacy level. For example, based on a relatively strict privacy requirement or first privacy level, the image parsing module 102 may classify electronic devices (e.g., the laptop 226), artwork (e.g., the artwork 230), health related objects (e.g., the syringe and the medical kit box 246), jewelry and related objects (e.g., the jewelry box 234), some combinations of objects (e.g., the candle 240 and the spoon 242) as relevant to privacy (i.e., privacy sensitive). Based on a less strict (i.e., relatively loose) privacy requirement or second privacy level (e.g., lower than the first privacy level), the image parsing module 102 may not classify some of the objects as relevant to privacy. For example, the image parsing module 102 may not classify the laptop 226, the medical kit box 234, and the artwork 230 as privacy sensitive objects. The different levels of privacy may provide an end user dynamic control options to generate synthetic images of a room 200 for different scenarios (e.g., provide to a third party, share with friends, share with work).

In some example embodiments, the image parsing module 102 may output masks of objects that are classified as being relevant to privacy. For example, pre-trained Mask R-CNN components of the image parsing module 102 may classify some objects in the room 200 as relevant to privacy as described above and may generate one or more masks of the particular objects. For example, a mask of an object may be a binary mask where pixels that correspond to the object or to a bounding box around the object have a particular value such that the object or the bounding box are blocked out (e.g., all white) by the mask as can be readily understood by those of ordinary skill in the art. The one or more masks may also include one or more objects (e.g., the ball 232) that are not relevant to either lighting design or privacy. The one or more masks generated by the image parsing module 102 may be used by other components of the image parsing module 102, by the image generation module 104, and/or by other components of the system 100. For example, one or more masks of particular objects may be used by the image generation module 104 of the system 100 to generate the synthetic image 110 that does not include the particular objects corresponding to the masks.

In some example embodiments, the image parsing module 102 may determine a color palette of the room 200 based on the RGB values of each pixel of the input image 108. For example, the image parsing module 102 may generate a list of colors present in the input image 108 along with the level of presence of each color (e.g., based on the number pixels). The image parsing module 102 may determine the color palette of the room 200 using software code that may or may not be based on neural networks.

In some example embodiments, the image generation module 104 may receive or otherwise obtain some or all of the information determined by the image parsing module 102. For example, the image generation module 104 may receive one or more of room type, design type, color palette, detected objects along with labels, relative locations of objects, and the objects classified as relevant to lighting design and may generate a drawing (i.e., the synthetic image 110) that indicates the relative locations of the objects that are classified as relevant to lighting design. To illustrate, the information from the image parsing module 102 may be in a standard format or another format interpretable by the image generation module 104. The drawing may be generated in a standard format that is viewable by an image view as can be readily understood by those of ordinary skill in the art. To illustrate, the image generation module 104 may include software code that generates a drawing from the information provided by the image parsing module 102. For example, the drawing generated from the image generation module 104 may represent objects using generic shapes. Labels (e.g., class labels) associated with the objects classified as relevant to lighting design may be overlaid on the respective generic shapes.

In some alternative embodiments, objects classified as relevant to lighting design may be represented in the drawing using generic equivalent objects selected based on the labels associated with the lighting design relevant objects. For example, the drawing may show a generic sofa that corresponds to the sofa 206. The image generation module 104 may use some of the received information such as room type and design style to select particular generic objects. In some embodiments, a generic equivalent object can include, but is not limited to, a replacement object for an object (e.g., removed object, filtered object, edited out object) that a general person recognize or understand the type of object the replacement object replaced (e.g., sofa, desk, table) but would not be able to identify the actual original object having particular details the owner wishes to protect (e.g., details removed, color schemed changed, personal items on object removed, etc.). For example, the generated drawing may show a replacement mirror but without the reflected image of the objects in the room 200. The image generation module 104 may also use the relative location information to position objects in the generated drawing. The image generation module 104 may also associate metadata with the drawing, where the metadata may include information such as room type, design style, locations of objects, etc. received from the image parsing module 102. Alternatively, the image generation module 104 may provide the information along with the drawing in a separate file instead of as metadata.

In some example embodiments, instead of generating a drawing as described above, the image generation module 104 may include one or more neural network components that perform image-to-image translation of the input image 108 to generate the synthetic image 110. In general, image-to-image translation may transfer images from one domain to another domain while preserving representations of image content except for particular objects intended to be excluded. To illustrate, the synthetic image 110 generated by the image generation module 104 may include objects classified as relevant to lighting design while objects classified as privacy sensitive are left out. The objects (e.g., second object) can be removed or left out of the synthetic image 110 for meeting one or more privacy settings. The privacy settings can be selected based at least on a user, a setting of the space, or a type of object. For example, one or more CNN components of the image generation module 104 may include one or more Generative Adversarial Networks (GANs) that each include a generator and a discriminator and operate to generate an image as readily understood by those of ordinary skill in the art. Some information related to GAN-based image synthesis is provided in L. Wang, W. Chen, W. Yang, F. Bi and F. R. Yu, “A State-of-the-Art Review on Image Synthesis With Generative Adversarial Networks,” in IEEE Access, vol. 8, pp. 63514-63537, 2020.

In some example embodiments, the image generation module 104 may generate a mask corresponding to one or more objects based on user input. To illustrate, a user input may provide privacy settings and/or one of more class labels to indicate objects that should be left out of the synthetic image 110. For example, such objects may be objects that were classified as relevant to lighting design by the image parsing module 102. A user input may also indicate the room type, the design style, and/or other information. To illustrate, instead of the image parsing module 102 determining some parameters such as room type, design style, etc., such information may be received by the image generation module 104 as user input.

In some example embodiments, the image generation module 104 may receive or otherwise obtain the input image 108 and may perform image-to-image translation of the input image 108 to generate the synthetic image 110 based on the one or more masks provided by the image parsing module 102. As described above, the image parsing module 102 may generate one or more masks corresponding to objects classified as privacy sensitive (i.e., relevant to privacy). The image generation module 104 may generate the synthetic image 110 such that objects classified as privacy sensitive (e.g., corresponding to one or more privacy settings) by the image parsing module 102 are left out of the synthetic image 110. For example, the jewelry box 234, the spoon 242, and the syringe 244, which may be classified by the image parsing module 102 as privacy sensitive, may be left out of the synthetic image 110. The one or more masks may also be applicable to objects (e.g., the ball 232) that are not relevant to lighting design as classified by the image parsing module 102, and such objects may also be left out of the synthetic image 110, which may have the effect of reducing unwanted clutter from appearing in the synthetic image 110. Portions of the synthetic image 110 that would have been occupied by the left-out objects may be inpainted such that the absence of the left-out objects is not noticeable as can be readily understood by those of ordinary skill in the art. If an object is classified as being relevant to lighting as well as privacy, the image generation module 104 may include in the synthetic object 110 a modified object corresponding to the particular object. For example, the mirror 236 that may be classified as relevant to both lighting and privacy may be included in the synthetic image 110, where reflections of objects that may be shown in the mirror 236 are left out (e.g., due to privacy settings).

In some example embodiments, the image generation module 104 may generate two versions of the synthetic image 110, where one version is generated based on masks from the image parsing module 102 corresponding to relatively strict privacy requirements (e.g., first level of privacy requirements, settings) and where the other version is generated based on masks from the image parsing module 102 corresponding to relatively loose privacy requirements (e.g., second level of privacy requirements, settings). For example, the synthetic image 110 generated based on the relatively strict privacy requirement may be provided to multiple lighting design professionals to get an initial response. Upon selecting a lighting design professional based on the synthetic image 110 corresponding to the relatively strict privacy requirements, the synthetic image 110 generated based on the relatively loose privacy requirement may be provided to the selected lighting design professional.

In some example embodiments, in addition to excluding some privacy sensitive objects, the image generation module 104 may include one or more new objects in the synthetic image 110 that are not in the input image 108. For example, the image generation module 104 may include one or more CNN components (e.g., one or more GANs) that are configured to include one or more new objects in the synthetic image 110 that are not in the input image 108 as can be readily understood by those of ordinary skill in the art. For example, a GAN may be used to generate a composite image by combining an image of a foreground object (e.g., an object to be added) with a background image (e.g., an input image or an intermediate image that has some objects removed relative to an input image.)

In some example embodiments, the image generation module 104 may add one or more new objects that do not affect lighting design decisions while adding a level of privacy by introducing one or more objects that are not in the room 200. For example, the image generation module 104 may add an object that is compatible with the design style of the room 200. Alternatively or in addition, the image generation module 104 may add one or more new objects as indicated by a user input. For example, the synthetic image 110 may include one or more of a piece of furniture (e.g., a chair or a shelf), an electronic device (e.g., a music player), utensils, etc. that are not in the input image 108 that are not shown in the input image 108. Data that may be used to add one or more new objects may be accessed from a storage device of a device executing the system 100. By informing the lighting designer receiving the synthetic image 110 that the synthetic image 110 includes virtual objects, the impact on the privacy of the owner/occupant of the room 200 may be reduced because the lighting designer does not know whether an object in the synthetic image 110 is really in the room 200 or has been virtually added.

In some example embodiments, the image generation module 104 may also associate (e.g., embed) metadata with the synthetic image 110, where the metadata may include information such as room type, design style, locations of objects, etc. received from the image parsing module 102. That is, the metadata is transmitted automatically along with the synthetic image 110 when the synthetic image 110 is sent to, for example, a lighting design professional. Alternatively, instead of metadata, the image generation module 104 may provide the information separately but along with the synthetic image 110.

In some example embodiments, the image verification module 106 may receive the synthetic image 110 and determine whether design style of the room 200 as shown in the synthetic image 110 matches the design style of the room 200 as shown in input image 108. To illustrate, the image verification module 106 may include one or more neural networks (e.g., a CNN) that are pre-trained to perform design style classification. For example, the image verification module 106 may classify the room 200 as shown in the input image 108 as modern, casual, classic, natural, or another design style in a manner described above with respect to the image parsing module 102. The image verification module 106 may also classify the design style of the room 200 as shown in the synthetic image 110 as modern, casual, classic, natural, or another design style in a manner described with respect to the image parsing module 102 and the input image 108. In some alternative embodiments, the image verification module 106 may receive the design style classification with respect to the input image 108 from the image parsing module 102.

In some example embodiments, a comparison module of the image verification module 106 may compare the two classifications of the design styles of the room 200 and determine whether the design styles match (e.g., both are casual). If the design styles match, the synthetic image 110 may be provided to a user for approval or the image verification module 106 may approve the synthetic image 110 through approval settings executed by the image verification module 106. The approval settings can include settings or requirements previously provided by a user, an administrator and/or default settings. If the design styles do not match, the image generation module 104 may receive feedback from the image verification module 106 (e.g., through backpropagation or as an external input) and regenerate the synthetic image 110. If the design styles match above a pre-defined threshold, the image generation module 104 may receive from the image verification module 106 the resulting match score. The image generation module 104 may keep regenerating the synthetic image 110 until the room 200 as captured in the input image 108 and in the synthetic image 110 has matching design styles above a threshold metric for the matching.

In some example embodiments, the image verification module 106 may check the privacy level of the synthetic image 110. For example, the image verification module 106 may perform object detection and classification to determine whether some objects such as health related objects (e.g., the syringe 244) and jewelry related objects (e.g., the jewelry box 234) are not included in the synthetic image 110. To illustrate, some objects may be designated as having high privacy sensitivity (e.g., objects that may induce burglary), and the image verification module 106 determine whether such objects are present in the synthetic image 110. If such objects are detected, the image verification module 106 may provide feedback indicating the detection of such objects, and the image generation module 104 may regenerate the synthetic image 110 without the identified objects. Alternatively, the image verification module 106 may request a user input indicating whether the inclusion of such objects in the synthetic image 110 is acceptable.

In some example embodiments, the image verification module 106 may check for structural similarity between the input image 108 and the synthetic image 110. Because one or more objects present in the image 108 may be absent from the synthetic image 110, some dissimilarity between the two images is expected. The image verification module 106 may perform a structural similarity check to ensure that the images are not excessively dissimilar. For example, the image verification module 106 may determine structural similarity (SSIM) index of the input image 108 and the synthetic image 110. The SSIM index is a metric used to indicate the similarity between two images as known to those of ordinary skill in the art. If the SSIM index is below a threshold (e.g., 0.75 on a scale of 0 to 1.0), where the threshold is set account for expected level of dissimilarity, the image verification module 106 may provide feedback indicating that the images 108 and 110 are too dissimilar, and the image generation module 104 may regenerate the synthetic image 110 in response to the feedback.

In some example embodiments, the synthetic image 110 may be provided to a user for approval after image quality checks performed by the image verification module 106 are satisfactorily completed. The synthetic image 110 may be sent to one or more lighting design professionals if the user approves the synthetic image 110. As described above, the synthetic image 110 may be generated based on strict privacy requirements for initial transmission to multiple lighting design professionals. By using relatively strict privacy requirements to generate the synthetic image 110 for initial transmission, more privacy protection is afforded to the user until a particular lighting design professional is selected. The strict privacy requirements can include a first level of privacy or a higher level of privacy as compared to looser privacy requirements or a second, different privacy level.

After selecting a lighting design professional, the synthetic image 110 generated based on looser privacy requirements may be sent to the selected lighting design professional. Because the synthetic image 110 is generated to adequately represent the lighting related characteristics of the room 200 as represented in the input image 108, a lighting design professional can use the synthetic image 110 to satisfactorily perform the lighting design of the room 200. For example, based on the synthetic image, a lighting professional may suggest light fixtures for retrofitting, free standing light fixtures, tabletop light fixtures, lighting scenes, dim levels, CCTs, dynamic lighting characteristics, light distribution, a wall location of a control device, etc.

Using the synthetic image 110 instead of the input image 108 can provide a level of privacy protection to the owner/occupant of the room 200. The level of privacy protection can be variable (e.g., dynamically modifiable) and selected or modified based in part on an intended use of the synthetic image 110 and to what party the synthetic image 110 is to be shared with. By using the synthetic image 110 to request lighting design services, a user can protect their privacy while providing adequate information for a lighting design professional to remotely perform the lighting design of the room 200.

In some example embodiments, user inputs may be provided to more or different components of the system 100 than shown in FIG. 1 without departing from the scope of this disclosure. In some example embodiments, the input image 108 may be a panoramic image that may show more of an area (e.g., more of the room 200) than a non-panoramic image. In some example embodiments, the system 100 may operate on multiple images of the room 200 individually and may generate multiple synthetic images that may be used for the remote lighting design of the room 200 without departing from the scope of this disclosure.

In some example embodiments, the image generation module 104, and the image verification module 106 may include components that are based on other neural network architectures, such as a variational autoencoder architecture, instead of or in addition to GANs. In some example embodiments, components (e.g., Transformers) that are based on neural network architectures other than CNN may be included in the image parsing module 102, in the image generation module 104, and/or in the image verification module 106 in addition to or instead of CNN based components without departing from the scope of this disclosure. In some example embodiments, non-neural network software code and components may be used in the image parsing module 102, the image generation module 104, and the image verification module 106 in addition to neural network based software code and components without departing from the scope of this disclosure.

In some alternative embodiments, other image editing and synthesis methods (e.g., text-to-image translation) than described above may be used in the generation of the synthetic image 110 without departing from the scope of this disclosure. For example, a text instruction to include a new object or to modify an existing object may be provided by a user, and the image generation module 104 may perform text-to-image translation to execute the operation. In some example embodiments, the image verification module 106 may perform some but not all of the image quality checks without departing from the scope of this disclosure. For example, the image verification module 106 may check for design style match but may not perform the privacy level and structural similarity checks. In some alternative embodiments, the image verification module 106 may be omitted without departing from the scope of this disclosure. In some alternative embodiments, the system 100 may include other components than shown in FIG. 1 without departing from the scope of this disclosure. In some alternative embodiments, some components of the system 100 may be integrated in a single component. In some alternative embodiments, the room 200 may include more, fewer, or different objects than shown in FIG. 2 without departing from the scope of this disclosure. For example, the room 200 may include a TV or other appliances that may be relevant to lighting design. In some example embodiments, the input image 108 may be an image of a different room type than the room 200 without departing from the scope of this disclosure. For example, the input image 108 may be an image of a living room, a bedroom, a kitchen, a game room, a den, etc.

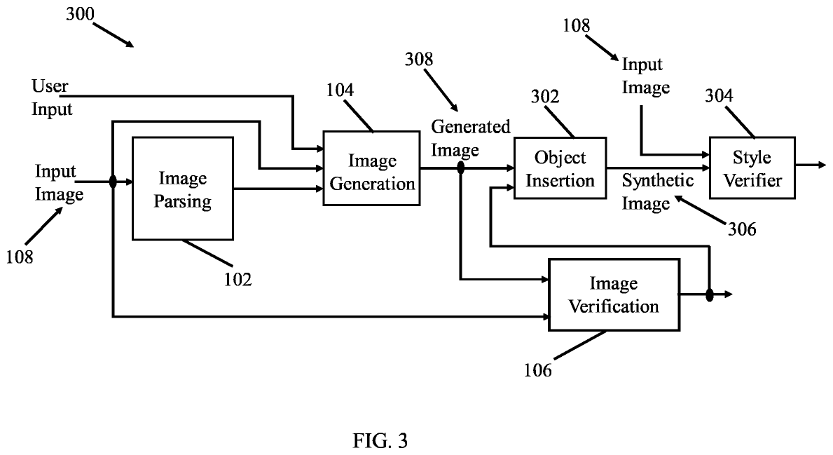

FIG. 3 illustrates a functional system 300 for generating a synthetic image 306 of a space (e.g., the room 200 of FIG. 2) according to another example embodiment. In some example embodiments, the system 300 includes the image parsing module 102, the image generation module 104, and the image verification module 106 that operate in substantially the same manner as described above with respect to FIGS. 1 and 2. The system 300 may also include design style verifier 304 that checks whether the design style of the synthetic image 306 matches the design style of the input image 108 in the same manner as described with respect to the image verification module 106, the input image 108, and the synthetic image 110 in FIG. 1.

In some example embodiments, in contrast to the system 100, the system 300 may include an object insertion module 302 that generates the synthetic image 306 from a generated image 308 generated by the image generation module 104. To illustrate, in contrast to the synthetic image 110 described with respect to the system 100 and FIG. 1, the generated image 308 generated by the image generation module 104 in the system 300 may not include objects that are not in the input image 108. Instead, the object insertion module 302 may generate the synthetic image 306 from the generated image 308 by inserting one or more new objects in a manner described with respect to the image generation module 104 and FIG. 1.

In some example embodiments, the image verification module 106 in the system 300 may operate in the manner described with respect to the system 100 and FIG. 1. To illustrate, the image verification module 106 in the system 300 may receive the input image 108 and the generated image 308 and perform the image quality checks described above with respect to the image verification module 106 in the system 100.

In some example embodiments, the design style verifier 304 may receive the synthetic image 306 and the input image 108 and check whether the design style of the two images match in the same manner as described with respect to the image verification module 106 and FIG. 1. If the design styles of the room 200 in the images 108 and 306 do not match, the design style verifier 304 may provide feedback (e.g., through backpropagation or as an external input) to the object insertion module 302 that may regenerate the synthetic image 306. In some example embodiments, the design style verifier 304 may check for design style match if the image verification module 106 indicates a design style match between the input image 108 and the generated image 308.

In some example embodiments, the synthetic image 306 may be provided to a user for approval after image quality checks performed by the image verification module 106 and the design style verifier 304 are satisfactorily completed. The synthetic image 306 may be sent to one or more lighting design professionals if the user approves the synthetic image 306. As described above with respect to the synthetic image 110 and FIG. 1, the synthetic image 306 may be generated based on strict privacy requirements (e.g., increased level of privacy) for initial transmission to multiple lighting design professionals. By using relatively strict privacy requirements to generate the synthetic image 306 for initial transmission, more privacy protection is afforded to the user until a particular lighting design professional is selected. The synthetic image 306 generated based on looser privacy requirements (e.g., decreased or lower level of privacy) may be subsequently sent to the selected lighting design professional.

Using the synthetic image 306 instead of the input image 108 can provide a level of privacy protection to the owner/occupant of the room 200. By using the synthetic image 306 to request lighting design services, a user can protect their privacy while providing adequate information for a lighting design professional to remotely perform the lighting design of the room 200.

In some example embodiments, user inputs may be provided to more or different components of the system 300 than shown in FIG. 3 without departing from the scope of this disclosure. In some example embodiments, the image generation module 104, the image verification module 106, the object insertion module 302, and the design style verifier 304 may include components that are based on other neural network architectures, such as a variational autoencoder architecture, instead of or in addition to GANs. In some example embodiments, components that are based on neural network architectures other than CNN may be included in the image parsing module 102, the image generation module 104, the image verification module 106, the object insertion module 302, and the design style verifier 304 without departing from the scope of this disclosure. In some example embodiments, non-neural network software code and components may be used in the image parsing module 102, the image generation module 104, the image verification module 106, the object insertion module 302, and the design style verifier 304 in addition to neural network based software code and components without departing from the scope of this disclosure.

In some alternative embodiments, other image editing and synthesis methods (e.g., text-to-image translation) than described may be used in the generation of the synthetic image 306 without departing from the scope of this disclosure. For example, a text instruction to include a new object or to modify an existing object may be provided by a user, and the object insertion module 302 may execute text-to-image translation to perform the operation. In some alternative embodiments, the image verification module 106 may be omitted without departing from the scope of this disclosure. In some alternative embodiments, the system 300 may include other components than shown in FIG. 3 without departing from the scope of this disclosure. In some alternative embodiments, some components of the system 300 may be integrated in a single component.

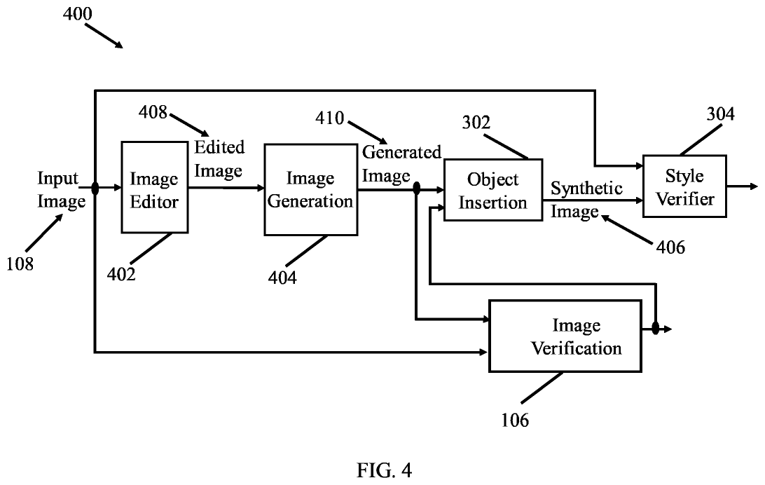

FIG. 4 illustrates a functional system 400 for generating a synthetic image 406 of a space (e.g., the room 200 shown in FIG. 2) according to another example embodiment. In some example embodiments, the system 400 includes an image editor 402, an image generation module 404, the image verification module 106, the object insertion module 302, and the design style verifier 304. The image editor 402 may be used to edit the input image 108 of the room 200 to block/mask out (e.g., cover by a filled shape such as a rectangular shape) objects that are relevant to the privacy of the owner/occupant of the room 200. For example, the image editor 402 may include software code executable to block/mask out objects in the input image 108 in response to user inputs. The image editor 402 may also block/mask out objects that the user deems are irrelevant to lighting design but relevant to privacy. To illustrate, the image editor 402 may include or interface with an editor, such as PHOTOSHOP, ADOBE, or other image editor products, to block/mask out objects in response to user inputs. The image editor 402 may output an edited image 410 that has some objects blocked/masked out.

In some example embodiments, the image generation module 404 may receive the edited image 408 and perform inpainting of the edited image 408 to generate the generated image 410. For example, the image generation module 404 may include one or more CNN components To illustrate, the image generation module 404 may perform inpainting of the masked portion of the edited image 408 to match the surrounding background of the edited image 408 as can be readily understood by those of ordinary skill in the art.

In some example embodiments, the system 400 may include the object insertion module 302 described with respect to the system 300 shown FIG. 3. The object insertion module 302 may generate the synthetic image 406 from the generated image 410. To illustrate, in contrast to the synthetic image 110 described with respect to the system 100 and FIG. 1, the generated image 410 may not include objects that are not in the input image 108. Instead, the object insertion module 302 may generate the synthetic image 406 from the generated image 410 by inserting one or more new objects in a manner described with respect to the image generation module 104 and FIG. 1.

In some example embodiments, the image verification module 106 in the system 400 may operate in the manner described with respect to the system 100 and FIG. 1. To illustrate, the image verification module 106 in the system 400 may receive the input image 108 and the generated image 410 and perform the image quality checks described above with respect to the image verification module 106 in the system 100.

In some example embodiments, the design style verifier 304 may receive the synthetic image 406 and the input image 108 and check whether the design style of the two images match in the same manner as described with respect to the image verification module 106 and FIG. 1. If the design styles of the room 200 in the images 108 and 406 do not match, the design style verifier 304 may provide feedback (e.g., through backpropagation or as an external input) to the object insertion module 302 that may regenerate the synthetic image 406. In some example embodiments, the design style verifier 304 may check for design style match if the image verification module 106 indicates a design style match between the input image 108 and the generated image 410.

In some example embodiments, the synthetic image 406 may be provided to a user for approval after image quality checks performed by the image verification module 106 and the design style verifier 304 are satisfactorily completed. The synthetic image 406 may be sent to one or more lighting design professionals if the user approves the synthetic image 406. As described above with respect to the synthetic image 110 and FIG. 1, the synthetic image 406 may be generated based on strict privacy requirements for initial transmission to multiple lighting design professionals. By using relatively strict privacy requirements (e.g., first level of privacy, increased level of privacy) to generate the synthetic image 406 for initial transmission, more privacy protection is afforded to the user until a particular lighting design professional is selected. The synthetic image 406 generated based on looser privacy requirements (e.g., second level of privacy, lower level of privacy) may be subsequently sent to the selected lighting design professional.

Using the synthetic image 406 instead of the input image 108 can provide a level of privacy protection to the owner/occupant of the room 200. By using the synthetic image 406 to request lighting design services, a user can protect their privacy while providing adequate information for a lighting design professional to remotely perform the lighting design of the room 200.

In some example embodiments, user inputs may be provided to more or different components of the system 400 than shown in FIG. 4 without departing from the scope of this disclosure. In some example embodiments, the image generation module 404, the image verification module 106, the object insertion module 302, and the design style verifier 304 may include components that are based on other neural network architectures, such as a variational autoencoder architecture, instead of or in addition to GANs. In some example embodiments, components that are based on neural network architectures other than CNN may be included in the image generation module 404, the image verification module 106, the object insertion module 302, and the design style verifier 304 without departing from the scope of this disclosure. In some example embodiments, non-neural network software code and components may be used in the image generation module 404, the image verification module 106, the object insertion module 302, and the design style verifier 304 in addition to neural network based software code and components without departing from the scope of this disclosure.

In some alternative embodiments, other image editing and synthesis methods (e.g., text-to-image translation) than described may be used in the generation of the synthetic image 406 without departing from the scope of this disclosure. For example, the function of the image editor 402 may be performed by text-to-image translation neural network components. In some alternative embodiments, the image verification module 106 may be omitted without departing from the scope of this disclosure. In some alternative embodiments, the system 400 may include other components than shown in FIG. 4 without departing from the scope of this disclosure. To illustrate, the system 400 may include the image parsing module 102 that is coupled to receive and parse the edited image 408 to the obtain information such as room type, design style, and other information as described with respect to FIG. 1. For example, image parsing module 102 may provide the information to the image generation module 404 that may generate the generated image 410 based on the information. In some alternative embodiments, some components of the system 400 may be integrated in a single component.

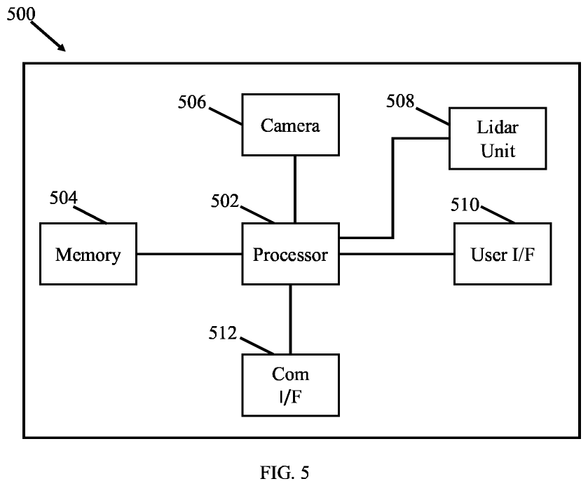

FIG. 5 illustrates a device 500 for generating a synthetic image of a space for lighting design, according to an example embodiment. In some example embodiments, the device 500 may be used to implement the functionals 100, 300, and 400 of FIGS. 1, 3, and 4, respectively. In some example embodiments, the device 500 may include a processor unit 502, a memory unit 504, a camera unit 506, a Lidar unit 508, a user interface 510, a communication interface 512, and other component(s) such as a ToF (time of flight) sensor unit. For example, the processor unit 502 may include one or more microprocessor and/or a graphic processing unit configured to execute software code for the device 500 to perform operations described herein with respect to the functional systems 100, 300, 400. For example, the software code (e.g., neural network and other software code) executable by the processor unit 502 to perform the operations described herein with respect to the systems 100, 300, 400 may be stored by the memory device 504.

In some example embodiments, the memory unit 504 may include one or more memory devices, such as a flash memory device, a static random access memory device, and/or other types of memory devices as can be readily understood by those of ordinary skill in the art. In some example embodiments, data such as image data corresponding to the input image 108, the synthetic images 110, 306, and 406, the generated images 308 and 410, the edited image 408, mask data, and Lidar information used and/or generated by the device 500 may be stored in the memory unit 504.

In some example embodiments, the camera unit 506 may be used to capture the input image 108 of the room 200 and other images that can be used as input images to the systems 100, 300, and 400. The Lidar unit 508 may be used to obtain Lidar information that can be used or otherwise processed by the processor unit 502 along with the input image 108 as described above with respect to FIGS. 1 and 2.

In some example embodiments, the processor unit 502 may receive user input and provide information to a user via the user interface 510. For example, the processor unit 502 may request approval of the synthetic images 110, 306, 406 from the user via the user interface 510. As another example, during the execution of the image parsing module 102, the processor unit 502 may request a user to indicate whether an object should be classified as privacy sensitive. To illustrate, the user interface 510 may include a touch screen that may be used to receive user inputs and to display information as can be readily understood by those of ordinary skill in the art. Alternatively or in addition, the user interface 510 may include other input devices such as keypad, a mouse, etc. without departing from the scope of this disclosure.

In some example embodiments, the processor unit 502 may transmit and receive information via the communication interface 512. The communication interface 512 may include one or more transmitters and/or receivers that use signals compatible with one or more wireless or wired communication standards for communicating with devices, for example, locally and/or over the internet.

In some example embodiments, the device 500 may be a smartphone, a tablet, a laptop, or another electronic device as can be readily understood by those of ordinary skill in the art with the benefit of this disclosure. In some example embodiments, the device 500 may include more or fewer components than shown in FIG. 5 without departing from the scope of this disclosure. In some alternative embodiments, one or more components of the device 500 may be omitted without departing from the scope of this disclosure. For example, in some example embodiments, the Lidar unit 508 may be omitted. In some alternative embodiments, some of the components of the device 500 may be integrated in a single component without departing from the scope of this disclosure.

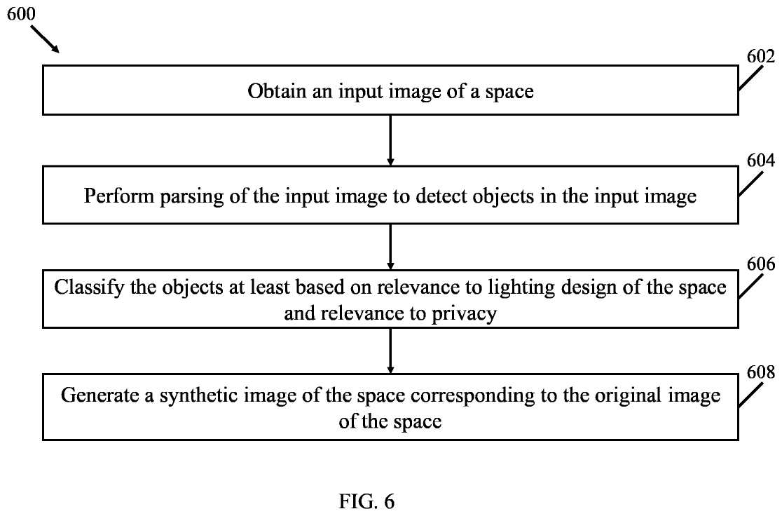

FIG. 6 illustrates a method 600 of generating a synthetic image of a space for lighting design according to an example embodiment. Referring to FIGS. 1-6, in some example embodiments, the method 600 includes, at step 602, obtaining the input image 108 of the space (e.g., the room 200). For example, the processor unit 502 may obtain the input image 108 from the memory unit 504. To illustrate, the input image 108 may be captured by the camera unit 506, and the data corresponding to the input image 108 may be stored in the memory unit 504. In some embodiments, the input image 108 can be transmitted to the processing unit 502 of the device 500 or by the system 100 from a separate camera unit and/or imaging device. At step 604, the method 600 may include performing parsing of the input image 108 of the space to detect objects in the input image 108. For example, the processor unit 502 may execute software code corresponding to the image parsing module 102 to parse the input image 108 to detect objects such as the desk 202, the chair 204, etc. that are in the room 200.

In some example embodiments, at step 606, the method 600 may include classifying the objects detected in the input image 108 at least based on relevance to lighting design of the space and relevance to privacy as described above with respect to the image parsing module 102. For example, the processor unit 502 may execute software code corresponding to the image parsing module 102 to classify some of the objects in the room 200 (as detected in the input image 108) as relevant to lighting design and some other objects in the room 200 as relevant to privacy (i.e., privacy sensitive). The processor unit 502 may execute software code corresponding to the image parsing module 102 or the image generation module 104 to determine to include a first object (218) of the objects in the input image a synthetic image (110, 306) of the space from the input image of the space, for example, based at least in part because the first object is relevant to a lighting design object. The processor unit 502 may execute software code corresponding to the image parsing module 102 or the image generation module 104 to determine to leave out a second object (242, 244) of the objects in the input from the synthetic image, for example, based at least on one or more privacy settings. At step 608, the method 600 may include generating the synthetic image (e.g., the synthetic images 108, 306) of the space (e.g., the room 200) from the input image 108 of the space. For example, the processor unit 502 may execute software code corresponding to the image generation module 104 of the system 100 to generate the synthetic image 110. The processor unit 502 may also execute software code corresponding to the image generation module 104 of the system 300 and the object insertion module 302 to generate the synthetic image 306. A first object (e.g., the freestanding lamp 218 shown in FIG. 2) of the objects in the input image 108 may be included in the synthetic image, and a second object (e.g., the syringe 244 shown in FIG. 2) of the objects in the input image 108 may be left out from the synthetic image (e.g., due to privacy settings, meeting one or more privacy settings). In embodiments, the privacy settings are selected based at least on a user, a setting of the space, or a type of object. To illustrate, the first object may be relevant to the lighting design (e.g., correspond to a lighting design object), and the second object may be relevant to privacy (i.e., privacy sensitive, meet a privacy setting). Some other objects classified as relevant to lighting design may also be included in the synthetic image generated by the processor unit 502 executing the image generation module 104 and/or the object insertion module 302 as described with respect to FIGS. 1 and 3.

In some example embodiments, the method 600 may also include verifying whether a design style of the space (e.g., the room 200) as shown in the input image 108 matches a design style of the space as shown in the synthetic image (e.g., the synthetic image 110). The method 600 may also include generating a second synthetic image from the input image 108 of the space based on a loose privacy requirement that is less stringent than a strict privacy requirement used in generating a first synthetic image.

In some alternative embodiments, the method 600 may include more or fewer steps than shown without departing from the scope of this disclosure. In some alternative embodiments, the steps of the method 600 may be performed in a different order than shown without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

1. A computer-implemented method of generating a synthetic image of a space for lighting design, the method comprising:
obtaining an input image of the space;
performing parsing of the input image of the space to detect objects in the input image;
classifying the objects detected in the input image at least based on the objects corresponding to one or more lighting design objects of the space and privacy settings, wherein the privacy settings are selected based at least one a user a setting of the space, or a type of object;
determining one or more of the objects detected in the input image correspond to the privacy settings;
determining to include a first object of the objects in the input image a synthetic image of the space from the input image of the space, wherein the first object is relevant to a lighting design object;
determining, responsive to determining a second object corresponds to the privacy settings, to leave out the second object of the objects in the input from the synthetic image; and
generating the synthetic image of the space from the input image of the space, wherein the first object of the objects in the input image is included in the synthetic image, wherein the second object of the objects in the input image is left out from the synthetic image.

2. The method of claim 1, wherein the first object is a light fixture, a light transmissive object, or a light reflective object.

3. The method of claim 1, wherein the first object is a piece of furniture, an appliance, or an artwork.

4. The method of claim 1, wherein a third object that is in the input image is left out from the synthetic image based on desired lighting of the space.

5. The method of claim 1, wherein one or more new objects are in the synthetic image and wherein the one or more new objects are absent in the input image.

6. The method of claim 1, wherein the second object is determined to meet at least one privacy setting based on a proximity of the second object to a third object in the input image of the space.

7. The method of claim 1, wherein a third object in the input image that is a lighting design object of the space, corresponds to a privacy settings and is left out from the synthetic image.

8. The method of claim 1, wherein a third object in the input image that is a lighting design object of the space, corresponds to a privacy settings and is included in the synthetic image.

9. The method of claim 1, further comprising verifying whether a design style of the space as shown in the input image matches a design style of the space as shown in the synthetic image.

10. The method of claim 1, further comprising generating a second synthetic image from the input image of the space based on a loose privacy requirement that is less stringent than a strict privacy requirement used in generating the synthetic image.

11. A device for generating a synthetic image of a space for lighting design, the device comprising a processor configured to:
obtain an input image of the space;
perform parsing of the input image of the space to detect objects in the input image;
classify the objects in the input image of the space at least based on the objects corresponding to one or more lighting design objects of the space and privacy settings, wherein the privacy settings are selected based at least on a user, a setting of the space, or a type of object;
determine one or more of the objects detected in the input image correspond to the privacy settings;
determine to include a first object of the objects in the input image a synthetic image of the space from the input image of the space, wherein the first object is relevant to a lighting design object;
determine, responsive to determining a second object corresponds to the privacy settings, to leave out the second object of the objects in the input from the synthetic image; and
generate the synthetic image of the space from the input image of the space, wherein the first object of the objects in the input image is included in the synthetic image, wherein the second object of the objects in the input image is left out of the synthetic image.

12. The device of claim 11, wherein the first object is a light fixture, a light transmissive object, or a light reflective object.

13. The device of claim 11, wherein one or more new objects are in the synthetic image and wherein the one or more new objects are absent in the input image.

14. The device of claim 11, wherein the second object is determined to be a privacy-sensitive object based on a proximity of the second object to a third object in the input image of the space.

15. The device of claim 11, further the processor is further configured to verify whether a design style of the space as shown in the input image matches a design style of the space as shown in the synthetic image.
